(19) United States
(12) Patent Application Publication
(10) Pub. No.: US 2026/0189303 A1
(43) Pub. Date: Jul. 2, 2026

(54) Concurrent AM and FM over optical communication

(71) Applicant: Joseph Daniel Vance, Reno, NV (US)

(72) Inventor: Joseph Daniel Vance, Reno, NV (US)

(21) Appl. No.: 19/433,913

(22) Filed: Dec. 28, 2025

Related U.S. Application Data
(60) Provisional application No. 63/739,643, filed on Dec. 29, 2024.

(51) Int. Cl. H04B 10/50; H04L 27/02; H04L 27/10

(52) U.S. Cl. CPC H04B 10/505; H04L 27/02; H04L 27/10

(57) ABSTRACT

A communication system is disclosed where information is embedded in the frequency of an optical electromagnetic radiation carrier, and concurrently, information is embedded in the amplitude of the optical electromagnetic radiation carrier. The electromagnetic radiation carrier is then propagated and collected by a receiver. The receiver is composed of a demodulator that can determine frequency of the electromagnetic carrier independently of carrier amplitude. The demodulator then extracts information from the electromagnetic carrier frequency and amplitude. The demodulator utilizes dispersion adjacent to absorption in paramagnetic vapors to determine frequency, and can also measure signal amplitude.

### FIELD OF INVENTION

This invention relates to communication where information is modulated upon an electromagnetic carrier wave, the carrier propagates over some distance and a demodulator extracts the signal information from the carrier.

### BACKGROUND OF THE INVENTION

AM is an acronym for Amplitude Modulation, where information is embedded in the amplitude of a carrier wave. FM is an acronym for Frequency Modulation where information is embedded into the frequency of a carrier wave. In this case, the carrier wave is in the optical portion of electromagnetic wave spectrum, a region where a demodulator as specified below is can operate. The goal of this invention is to increase the information embedded and transmitted in the optical carrier wave by combining both AM and FM signals into a single optical carrier wave.

Amplitude Modulation and Frequency Modulation typically refer the embedding of analog signals into a carrier wave in the radio portion of the electromagnetic spectrum. Here, Amplitude Modulation and Frequency Modulation encompasses analog and/or digital information embedded upon an optical carrier wave. Thus Amplitude Modulation includes ASK or Amplitude Shift Keying, where digital information is embedded upon the optical carrier. Likewise Frequency Modulation includes FSK or Frequency Shift Keying where digital information is embedded upon the optical carrier wave.

The invention disclosed here overcomes difficulties encountered with transmitting information in free space. Communication between the ground and satellites in space with optical communication is difficult because of atmospheric turbulence and because aerosol particles disturb to the phase of optical signals. The effects are particularly troublesome for phase modulated optical signals, currently the method with the highest data rate. This invention seeks to overcome those difficulties as turbulence does not pose a problem and the optical signal phase is irrelevant. The optical signal need only propagate through the medium to transmit information. The invention disclosed here has the potential for higher data rates than can be attained by phase modulation.

The current invention claims benefit of provisional patent 63/739,643 with a filing date of Dec. 29, 2024. The current invention incorporates spectrometers known to the prior art with a listing referencing patents below. The order of the listing begins with the simplest spectrometer and increases in complexity and elements.

U.S. Pat. No. 9,091,590 Magneto-optic dispersion spectrometer

U.S. Pat. No. 9,366,572 Absorption line optical filters and spectrometers.

### BRIEF DESCRIPTION OF THE DRAWINGS

FIG. 1 shows the major components that comprise a concurrent amplitude modulated and frequency modulated over optical communication system.

FIG. 2 shows the major elements of a demodulator that comprises a portion of a concurrent amplitude modulated and frequency modulated over optical communication system.

FIG. 3 shows the major elements of a demodulator that comprises a portion of the concurrent amplitude modulated and frequency modulated of optical communication system.

### DETAILED DESCRIPTION OF THE INVENTION

Several drawings illustrate physical the attributes of optical modulators, optical demodulators, optical amplifiers, and lasers, along with quantities and elements that may be manifested with its construction, in accordance with embodiments of the present invention. Examples are described that have particular absorbing substances, mediums, transitions, wavelengths of complimentary light pairs, etc. for purposes of illustration. However, it should be noted that the choices of particular absorbing substance and particular transitions are abundant. Also, while corresponding to the chosen transitions, the wavelengths of the optical carrier have wide latitude of choice upon a continuum. Thus it is recognized that the apparatus and means described herein may vary without departing from the basic underlying concepts of the invention.

The current invention includes an optical spectrometer which is used as a demodulator. Spectrometers known to the prior art that may be included as an element into the current invention are listed above in the background of the invention. An optical demodulator extracts information that was embedded into an optical carrier wave. The optical carrier wave propagates through the optical demodulator which includes a rapidly changing birefringent medium. The change of polarization of the optical carrier wave from the birefringent medium is used to determine frequency and thus demodulate FM information from the optical carrier wave. How the optical carrier wave is impacted from the birefringent medium depends upon the frequency of the carrier wave and not the amplitude of the optical carrier wave. Thus, demodulation of FM information from the optical carrier wave is independent of any AM modulation that may be present.

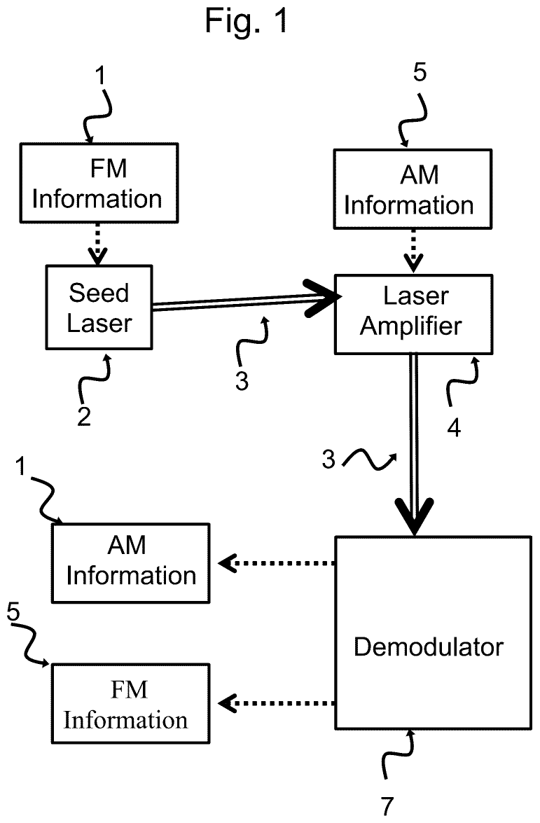

Applying the above concepts we can begin to explain one embodiment of the current invention. The major elements that may comprise a concurrent AM and FM over optical communication system is shown in FIG. 1. The current invention may include FM information 1 in a digital or analog format that may be embedded into the frequency of seed laser 2. In the case that the information is digital, the seed laser 2 may be tuned at a particular time to one of two distinct frequencies corresponding to one bit of information. The seed laser 2 may be tuned to one of many distinct frequencies corresponding to multiple bits of information. The seed laser 2 may be a tunable DBR (Distributed Bragg Reflection) laser that has tuning capability such as a Photodigm DBR laser operating at 852 nm near an absorption line of cesium. Lasers with electro-optic tuning will generate the fastest modulation. The light emitted from laser 2 is electromagnetic radiation carrier wave 3 which contains FM information 1 embedded into its frequency. Next electromagnetic radiation carrier wave 3 may be propagated into laser amplifier 4. Laser amplifier 4 may be a tapered diode amplifier that operates at wavelength 852 nm. Laser amplifier 4 may amplify the power of electromagnetic carrier wave 3 by an amount dictated by AM information 5, thus embedding AM information 5 into the electromagnetic radiation carrier wave 3. The AM information 5 may be embedded into electromagnetic radiation carrier wave 3 in synchronization with the FM information 1. In the case that information is in a digital format, there may be two amplitudes embedded into the electromagnetic radiation carrier wave 3 corresponding to a single bit of information, or there may be multiple amplitudes corresponding to multi-bit information. The electromagnetic radiation carrier wave 3 may then propagate some distance in a medium such as an optical fiber or it may travel in free space. In this way information is transported. Next the electromagnetic radiation carrier wave 3 is input into the demodulator 7. The demodulator 7 may extract AM information 5 and FM information 1 from the electromagnetic radiation carrier wave 3.

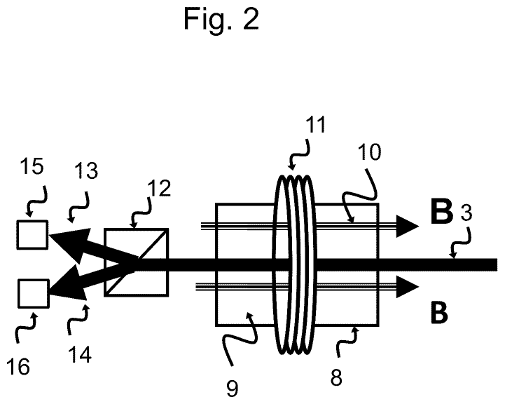

One embodiment of demodulator 7, in accordance with the current invention is shown in FIG. 2. The demodulator shown in FIG. 2 has elements and operation of the spectrometer of patent U.S. Pat. No. 9,091,590. The spectrometer used as a demodulator is described here because elements of it are included in the claims. The demodulator 7 is a device that measures frequency. It includes a birefringent medium that changes the polarization of the electromagnetic radiation carrier wave 3 an amount that depends upon frequency. By measuring how much the electromagnetic radiation carrier wave 3 polarization is changed from the initial input polarization, frequency is determined. The electromagnetic radiation carrier wave 3 enters a container 8 that contains a first absorbing substance 9. The first absorbing substance 9 may be atomic cesium vapor or atomic rubidium vapor or may be a paramagnetic molecule such as nitric oxide. A first magnetic field 10 produced by first magnet 11 permeates the first absorbing substance 9. Under the influence of the first magnetic field 10 the first absorbing substance 9 becomes a first birefringent medium for the electromagnetic radiation carrier wave 3. After propagating through the first absorbing substance 9, electromagnetic radiation carrier wave 3 travels to a linear polarizer 12 that partitions the electromagnetic radiation carrier wave 3 into two paths with the relative amount in each path dependent upon frequency. A portion of the electromagnetic radiation carrier wave 3 is collected by first detector 14 and another portion of the electromagnetic radiation carrier wave 3 is collected by second detector 15.

The signal magnitude detected by first detector 14 divided by the magnitude of second detector 15 is dependent only upon frequency, not upon signal strength. Thus there is a frequency correspondence to the ratio of the signals and it is used to determine frequency. The measured frequency is then recovered FM information 1 from FIG. 1. The sum of the magnitude detected in first detector 14 and second detector 15 is dependent only upon electromagnetic radiation carrier wave 3 strength so the AM information 5 from FIG. 1 is demodulated from that sum. An alternative method of determining frequency would be the difference of signal strength from first detector 14 from second detector 15 and then that difference divided by the sum of the signals from first detector 14 and second detector 15. It is best to synchronize the modulation of the AM information 5 to the FM information 2 to reduce signal processing.

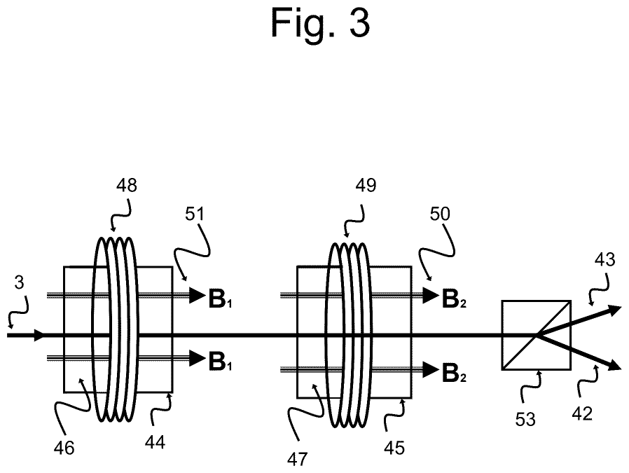

Another embodiment of the demodulator is shown in FIG. 3. This demodulator has elements and operation that is described by a spectrometer in U.S. Pat. Nos. 9,366,572 9,366,572. It is included here as elements are included in the claims. An first absorbing substance 46 is enclosed in a cell 44. A first magnetic field 51 permeates first absorbing substance 46. The first absorbing substance 46 and first magnetic field 51 combine to create a first birefringent medium for electromagnetic radiation carrier wave 41. A second absorbing substance 47 contained by a container 45 is permeated by a second magnetic field 50 produced by second magnet 49. The second absorbing substance 47 and second magnetic field 50 combine to create a second birefringent medium for the electromagnetic radiation carrier wave 3. Note that the idea behind using two birefringent mediums is that they are different, one birefringent medium has an absorption line higher in frequency than the operating region and the other birefringent medium has an absorption line lower in frequency than the operating region. Because birefringence is approximately anti symmetric about absorption the two regions complement each other making the birefringence stronger, making a higher resolution demodulator.

The electromagnetic radiation carrier wave 3 propagates through the first birefringent medium and the second birefringent medium and its polarization state is changed depending upon its frequency. Next the polarization of the electromagnetic radiation carrier wave 3 is measured by the polarizing beam splitter 53. Frequency and FM information 1 is determined from the first output 42 and second output 43 of the polarizing beam splitter 53. AM information is determined from the first output 42 and second output 43 of the polarizing beam splitter 53.

Frequency and FM information 1 can be determined by the difference divided by the sum of first output 42 and second output 43. AM information 5 can be determined from the sum of first output 42 and second output 43. An alternative method of determining frequency and FM information 1 of FIG. 1 is the ratio of first output 42 and second output 43

What is claimed is:

1. A communication system comprised of:
(a) a seed laser;
(b) a laser amplifier;
(c) a demodulator;
wherein an FM information is modulated into the frequency of electromagnetic radiation carrier wave produced and emitted from the seed laser;
wherein AM information is modulated into the amplitude of electromagnetic radiation carrier wave by the laser amplifier;
wherein the electromagnetic radiation carrier wave is propagated to the demodulator;
wherein FM information and AM information are both extracted from the electromagnetic radiation carrier wave by the demodulator.

2. The communication system of claim 1 wherein the demodulator is comprised of:
(2a) a first absorbing substance;
(2b) a first magnetic field that permeates the absorbing substance;
(2c) a polarizing beam splitter;
wherein the first absorbing substance and the first magnetic field combine to form a first birefringent medium for the electromagnetic radiation carrier wave;
wherein the electromagnetic radiation carrier wave propagates through the first birefringent medium and its polarization is rotated dependent upon the electromagnetic radiation carrier wave frequency;
wherein the electromagnetic radiation carrier wave frequency is determined from its polarization state by the polarizing beam splitter;
wherein FM information is extracted from the electromagnetic radiation carrier wave frequency;
wherein AM information is extracted from the amplitude of electromagnetic radiation carrier wave.

3. The communication system of claim 2 further comprising:
(3a) a second absorbing substance;
(3b) a second magnetic field;
wherein the second absorbing substance and the second magnetic field combine to form a second birefringent medium;
wherein the electromagnetic carrier wave propagates through the second birefringent medium and its polarization state is changed depending upon its frequency.
